(19) United States
(12) Patent Application Publication
(10) Pub. No.: US 2002/0032631 A1
(43) Pub. Date: Mar. 14, 2002

(54) Remote call-to-action messaging

(76) Inventor: David S. Rose, New York, NY (US)

Correspondence Address: RANDALL C BROWN, AKIN GUMP STRAUSS HAUER & FELD, P O BOX 688, DALLAS, TX, 75313

(21) Appl. No.: 09/728,739

(22) Filed: Dec. 1, 2000

Related U.S. Application Data
(60) Provisional application No. 60/168,365, filed on Dec. 1, 1999.

(51) Int. Cl. G06F 17/60

(52) U.S. Cl. 705/37

(57) ABSTRACT

A processor-based system and method for processing and communicating information between a host station and remote users or participants. A first database at a host station includes a pool of unique address identifiers that can be consecutively or randomly selected and associated with a participant when a predetermined event has occurred. The participant is contacted by the host station and given notification that the predetermined event has occurred, along with instructions to respond by using the selected address identifier. Upon participant contact with the host station, the selected address identifier is recognized as temporarily belonging to only the participant and determines that the participant has responded. Further verification of the participant's identity may be provided by requesting a password or other identifier. The participant may give appropriate instructions relating to the predetermined event. Once the participant is disconnected from the host station, the selected address identifier is then disassociated from the participant for use in a subsequent call to action.

### CROSS-REFERENCE TO RELATED APPLICATIONS

This application claims the benefit of U.S. Provisional Application Ser. No. 60/168,365 filed on Dec. 01, 1999.

### FEILD OF THE INVENTION

The present invention relates generally to a system and method for automatically sending a message to a user upon the occurrence of a particular event, and more particularly to a system and method for delivering a call-toaction message seeking a voice response from a user authorizing an action.

### DESCRIPTION OF THE RELATED ART

In the context of many present day commercial and business situations, there is a need to send a timely call-to-action to one or more persons seeking a voice or data response that will contain information identifying the person and/or the subject matter of the response.

As an example, such a call-to-action is needed in remote access auctions conducted using information transmission devices, such as networks, personal computers and wireless communications devices, which enable bidders to obtain information about items offered for sale and to enter bids for those items from a location remote from the items themselves. These auctions are typically conducted over an extended period of time, such as several days, or even longer. In the course of managing the auction, the auction operator will allocate to each item to be sold a particular identifying code, and each person wishing to bid for an item will be registered with the auction operator and allotted an individual identifying code. Because the auctions extend over a long period of time, bidders cannot continuously monitor the bidding to see if another has exceeded their bid. To encourage bidding, the auction system will typically notify a bidder that his or her bid has been exceeded by a subsequent bid, offering the bidder a chance to place a higher bid.

Existing call-to-action systems are less than ideal, and require the person responding to provide too much information for convenience. For example, U.S. Pat. No. 5,835,896 issued to Fisher et al. on Nov. 10, 1998, the disclosure of which is hereby incorporated by reference, describes a remote auction system wherein a group of customers can actively participate in a remote auction by placing bids over the Internet. When a customer has been out-bid, the customer is notified via electronic mail (e-mail) and may respond by including an increased bid in the reply message. This method is inconvenient to many users that do not have immediate access to the Internet, and may result in losing a desired item to another bidder. Before a response is validated in remote auctions, an item identifier, a bidder identifier, a bidder authentication password, and the response bid must all be provided. This makes the task of replying difficult, particularly when the person responding does not have immediate access to the identifiers representing that information.

### SUMMARY OF THE INVENTION

The present invention seeks to provide an improved system and method for providing a call-to-action. The present invention also has as an objective to improve and streamline existing procedures and to provide a system and method that can alert the person and avoid the need for the person to recall accurately various identification codes associated with the call when off-line.

According to one embodiment of the invention, a processor-based method for responding to a predetermined event associated with a host station and remote users comprises: providing a first database with a plurality of unique address identifiers that remote users can use to communicate with the host station; associating one of the address identifiers with a particular user when the predetermined event has occurred; selecting a first remote user that is affected by the predetermined event; associating the selected address identifier with the selected user; delivering an alert to the particular user that the predetermined event has occurred, the alert including the associated address identifier; identifying a response from the particular user by detecting the selected address identifier; receiving, at the host station, at least one user instruction for responding to the predetermined event; and disassociating the selected address identifier from the particular user so that address identifier can be used in a subsequent alert delivery.

According to a further embodiment of the invention, a processor-based method for responding to a predetermined event associated with a host station and remote users is provided. The method comprises: providing a first database with a plurality of telephone numbers that remote users can call to communicate with the host station; associating one of the telephone numbers with a particular remote user when the predetermined event has occurred; delivering an alert to the selected user that the predetermined event has occurred, the alert including the selected telephone number; dialing the selected telephone number by the selected user to connect the selected user to the host station; identifying the selected user by detecting the dialed telephone number; receiving, at the host station, at least one user instruction for responding to the predetermined event; and disassociating the selected telephone number from the selected user so that the selected telephone number can be used in a subsequent alert delivery.

According to an even further embodiment of the invention, a processor-based method for processing and communicating auction information between a host station and remote users is provided. The method comprises: providing a first database with a plurality of telephone numbers that remote users can call to communicate with the host station; providing a second database with auction information including a first high bid from a first remote user for an auction item; selecting one of the telephone numbers when the first high bid is exceeded by a second remote user; associating the selected telephone number with the one user; delivering an alert to the one user that the first high bid has been exceeded, the alert including the selected telephone number; dialing the selected telephone number by the one user to connect the one user to the host station; identifying the one user by detecting the dialed telephone number; receiving, at the host station, at least one instruction from the one user for responding to the second high bid; and disassociating the selected telephone number from the one user so that the selected telephone number can be used in a subsequent alert delivery.

In each of the above embodiments, the selected or one user may be further identified by prompting the user to enter an identifier, which may be compared to a stored identifier associated with the user.

Other objects and advantages of the invention will become apparent upon reading the following detailed description and appended claims, and upon reference to the accompanying drawings.

### BRIEF DESCRIPTION OF THE DRAWINGS

FIG. 1 is a schematic illustration of a system for alerting and interacting with a user when a predetermined event has occurred;

FIG. 2 is a schematic illustration of a method for alerting and interacting with a user when a predetermined event has occurred; and

FIG. 3 is a schematic illustration of a method for prompting interaction from a user after the user has responded to an alert.

### DETAILED DESCRIPTION OF THE PREFERRED EMBODIMENTS

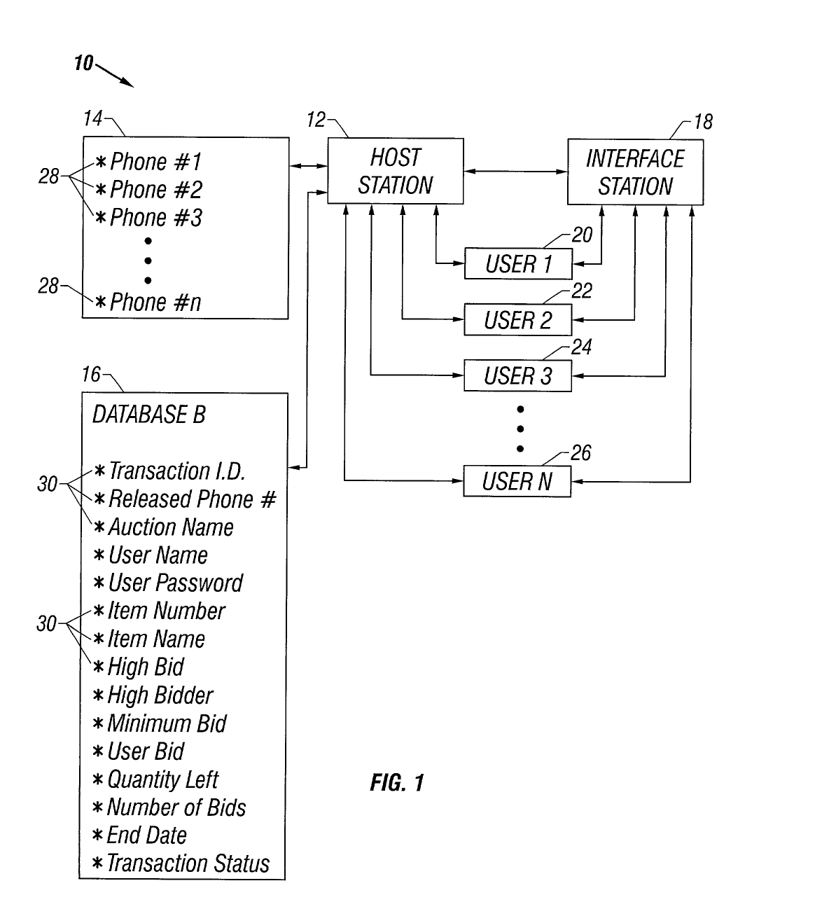

Referring now to the drawings, and to FIG. 1 in particular, a processor-based system 10 for alerting and interacting with a user when a predetermined event has occurred is illustrated. The system 10 includes a host station 12 connected to a first database 14 and a second database 16. An interface station 18, such as a voice recognition and processing station, is connectable to the host station 12. A plurality of user stations 20, 22, 24, 26 and so on, are in turn connectable to the host station 12 and the interface station 18. The first database 14 includes a plurality of captive telephone numbers 28. The second database 16 may include a data record of information relating to the subject matter of the call-to-action for each user, such as: user information, including but not limited to a transaction I.D., a selected telephone number from the first database 14 and the identity of the user to be called including the user name and password; item information, including but not limited to the auction name, item number, item name, highest bid, highest bidder, minimum bid, quantity of items left, number of bids received, the auction end date, and the current transaction status. The preliminary user information is preferably obtained during a preregistration procedure, which may take place over an internet connection with the host station. The initial registration may include personal information items as well as one or more items or services that the user desires to bid on.

In one exemplary embodiment, the host station is a processor-based system with an Internet domain site for displaying auction items as well as the current status information of each item.

The user station preferably includes a personal communication device, such as a telephone, that is able to connect to the host station through standard or wireless communication systems via one or more telephone numbers or the like. The user station may alternatively be in the form of an interactive television device, a display telephone, a pager, or any other interactive display currently in use or that may be developed in the future that is connectable to the host station via a telephone number or the like.

The interface station may be formed either as an integral part of the host station or separately therefrom. The host station may include software, hardware, or a combination of software and hardware for recognizing voice commands from the user stations and converting the voice commands into data commands for use at the host station. The interface station may also communicate voice prompts or other data to the user stations. Where the information at the user stations is to be entered through an input device such as a keypad, the user stations may communicate directly with the host station.

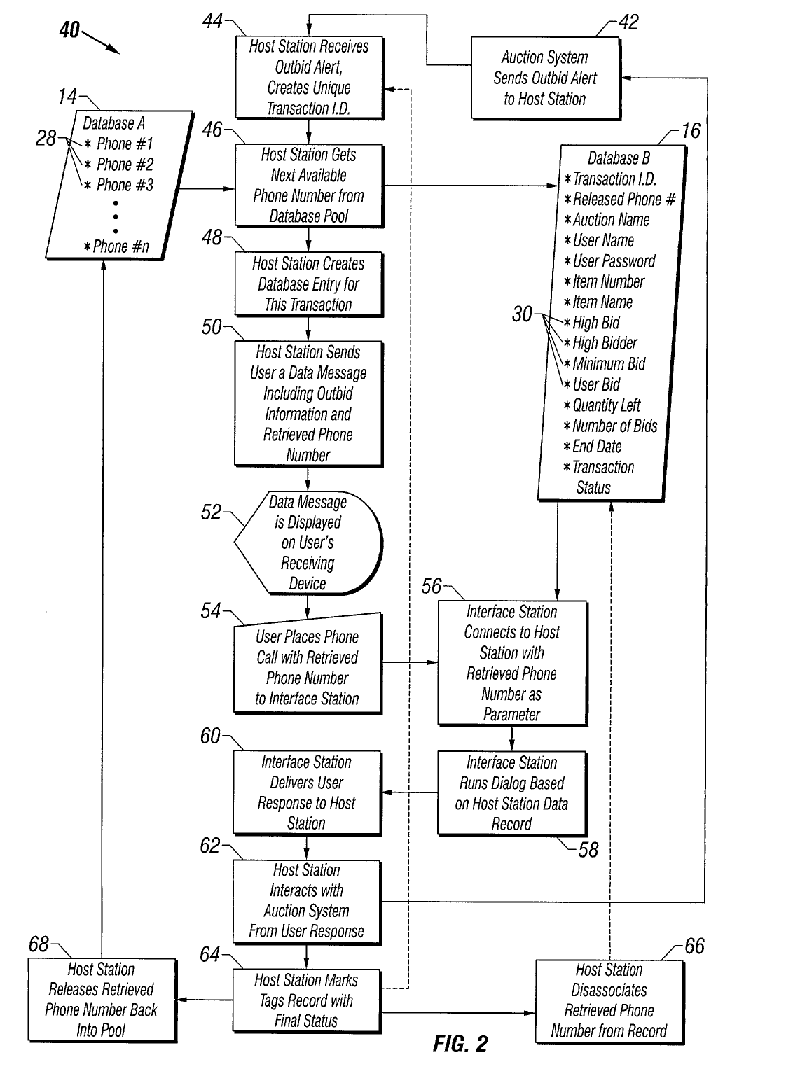

With reference now to FIG. 2, an exemplary method 40 for alerting and interacting with a user when a predetermined event has occurred is illustrated. The method 40 may be implemented in hardware, software, or a suitable combination of hardware, software and hard copy, and may be more than one software system operating on a general purpose user computing platform. As used herein, “a software system” shall mean one or more separate lines of code of a software program, one or more subroutines, one or more agents, one or more objects, one or more lines of code operating on different computer platforms, or other suitable software functionality. For example, a software system may include functionality that is provided by the operating system of the computing platform, plus other application-specific functionality.

The method 40 will be described, for illustrative purposes only, with respect to remote access auctions. It is to be understood that the method described herein can be applied to other call-to-action situations. Initially, the original values of the second database may be set at the host station 12 where it is decided that an item will be auctioned. In this embodiment, a database is provided that contains descriptions of items to be auctioned, a code identifying each item, and parameters for conducting the auction for that item. After entering personal information, potential purchasers or “users” may access information relating to the item and make a bid of that item from a remote location, typically using the Internet. During the auction, bids are received and recorded in the database creating a record that contains information as to the item, the amount of the bid and the identity of the bidder. This information is then used in method 40 to complete transactions associated with the auction.

Once the initial database 16 has been formed for a particular item, the method 40 is then implemented. In an initial step 42, an alert or flag is operated to inform the business or host station 12 that a predefined event has occurred. In the present example, the predefined event occurs when a subsequent bid made by one user for a particular auction item is higher than a previous bid made by another user.

In step 44, the alert is recognized at the host station 12 as a need to send a call-to-action to the user that has been outbid to give that user a chance to submit a subsequent higher bid. Other call-to-action events may include, but are not limited to, special short-term offers for sale, or electronic mail messages to which a response is desired. Once an alert is received, the host station 12 creates a transaction I.D. which is stored in the second database 16.

In step 46, the host station selects an available telephone number from the first database 14. Once selected, the host station creates a database entry in the second database 16 for the current transaction (step 48), wherein the selected telephone number is associated with the selected user information and the item information. The selected telephone number is then made unavailable in the first database so that a unique telephone number is associated with each transaction I.D.

Next, in step 50, the host station sends the user a data message that contains the selected telephone number and instructions to submit any new bid by calling the selected telephone number. This message can be sent, for example, by means of a text message delivered to a digital wireless telephone or alphanumeric pager. This number could also be automatically dialed by systems, such as digital wireless telephones, which directly support receipt of a text message with an embedded callback number. In step 52, the user's receiving device displays the data message to the user. Alternatively, a voice message can be sent with the same information.

The user responds to the call-to-action, in step 54, by calling the selected telephone number identified in the data message. Preferably, the telephone number is associated with an interface station 18 (FIG. 1) that recognizes voice input from the user. As shown in step 56, the interface station connects to the host station and retrieves the temporary data record associated with the selected telephone number. The interface station 18 then prompts, preferably by voice, the user for instructions on the action to be taken, based on the retrieved temporary data record (step 58). The user then dictates or keys in a password, which is transmitted by the interface station to the host station, as indicated in step 60. However the user does not need to communicate the information stored in the temporary data record in order to instruct the action. This results in considerable added convenience for the user and reduces the risk of error that occurs when the user has to communicate codes identifying, say, the user or the nature of the transaction. With the pre-assigned telephone number, the user to may additionally enter an identifier, such as a password, for the host station to verify that the right user has called the selected telephone number in order to access the host station and complete the transaction. In this manner, two levels of security are offered (the selected telephone number and the password), while the amount of information to be entered by a user is substantially reduced over prior art systems.

When the user has properly logged on or connected to the host station, the user may respond by offering a new bid that is higher than the previous bid. The offer may be entered by voice, DTMF tones from a telephone keypad, or as textual data from a data-capable device. Voice commands, if issued, are recognized by the interface station and converted into data commands. Where only data commands are to be issued by one or more users, the interface station may be eliminated.

In step 62, the host station responds to the user's instructions. When a new high bid is received from a user, the second database is updated (step 64) with the new auction information, including the new high bid, the highest bidder, the new minimum bid, and the number of bids. The selected telephone number is then removed from the second database 16 (step 66) and made available in the first database 14 (step 68) for subsequent use. When a new high bid is received, a flag is generated (step 42) as previously described, to thereby alert one or more previous users that a new high bid has been received. This process is repeated until the expiration of the auction date or other predetermined termination event. The quantity of telephone numbers in the first database may be more or less than the number of users, and is preferably less than the number of users, since the telephone number is recycled each time a new high bid has been received at the host station.

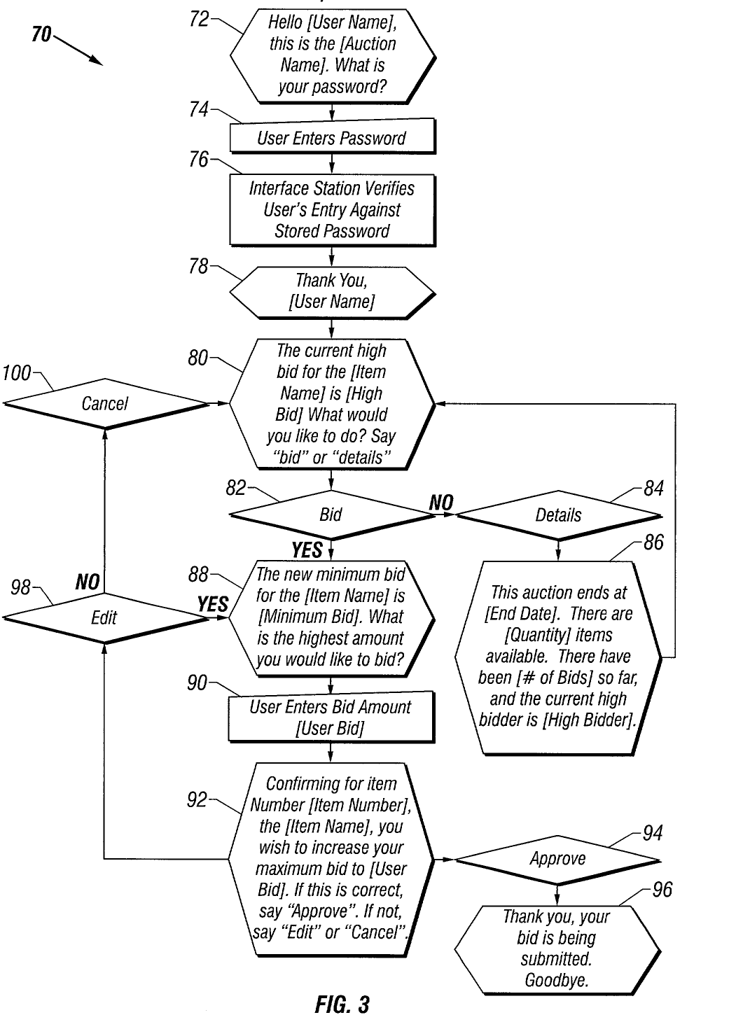

With reference now to FIG. 3, an exemplary method 70 for interacting with a user is illustrated. Once a user has responded to the call-to-action request from the host station by dialing the selected telephone number, the user is prompted to enter his or her password at step 72. The prompts may be audio, visual, or both. As shown, the prompts may be customized for each user by inserting data fields, such as the user and auction names, at appropriate locations. The data fields include information found in the second database 16. The user enters the password, preferably audibly (step 74), which is then recognized by voice recognition software at the interface station and then verified (step 76). At step 78, the user is informed that the password has been accepted. At step 80, the user is given information about the item, including the item name and the current high bid, which are taken from the second database 16. The user is then prompted to issue a voice command such as “bid” or “details.” The voice recognition software associated with the interface station interprets the command and accesses the appropriate response. For example, when the user issues the command “details” at block 84, the response at block 86 is accessed to inform the user of the particular item details, such as the auction end date, quantity of items available, the number of total bids to date, the current high bidder, and so on. The details for each item are kept and updated in the second database 16 each time the host station is accessed. After informing the user of the item details, the user is again prompted to bid or request further details at block 80. Although not shown, the user may also be prompted to cancel the current transaction through a voice command or by simply terminating the connection between the user and the interface station.

When the user issues the command “bid” at block 82, the response at block 88 is accessed to inform the user of the minimum acceptable bid for the item. The minimum acceptable bid is also located in the second database and is updated each time a new high bid is given. The current minimum bid may continue to be revised until a new high bid is obtained.

At block 90, the user enters a new high bid, either by voice or data. The new high bid is temporarily saved while being verified to determine if the new high bid meets the minimum bid requirement. If the new high bid is equal to or greater than the minimum bid, the user is prompted at block 92 to verify that the bid for the particular item has been correctly recorded by saying “approve”, “edit” or “cancel”. If the user approves the bid at block 94, the user is informed at block 96 that the bid is being submitted. The connection is then terminated between the user and the interface station. If the user issues the command “edit” at block 98, the user is again informed of the item information at block 88 and prompted to submit a new bid at block 90. If the user issues the command “cancel” at block 100, the user is again informed of the current high bid and prompted to enter a command at block 80, as previously discussed. Once the bid has been submitted and accepted by the host station, the database 16 is updated to include the new high bid, the new high bidder, the new minimum bid, the number of items left, and the new number of bids.

From the foregoing, the present invention improves and streamlines existing call-to-action procedures by providing a system and method for alerting one or more users when a predetermined event has occurred and for permitting quick connection to the pertinent information where online access to the host station or business is normally not feasible. With only a single identifier to be remembered, the user can actively and securely participate in the call-to-action without the disadvantages of recalling various identifiers and other information codes associated with the prior art, especially when off-line.

Although a remote auction has been particularly described in connection with an exemplary example of the present invention, it is to be understood that the invention is not limited thereto. The present invention is generally applicable in numerous situations in which a remote response to a call-to-action is desirable. By way of example, alerts for specific calls-to-action may be received from electronic mail messages, automatic calendar reminders, real-time purchase of information services, special advertising offers, banking and credit card companies, process control systems, electronic commerce, security trading entities, and other entities where quick access to information and quick transactions are desirable. Moreover, although the use of telephone numbers as unique identifies have been given by way of example, it is to be understood that other unique address identifies can be used, such as pager identifier numbers, website addresses, email addresses, security codes, embedded data, and so on. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A processor-based method for responding to a predetermined event associated with a host station and remote users, the method comprising:
providing a first database with a plurality of telephone numbers that remote users can call to communicate with the host station;
associating one of the telephone numbers with a particular user when the predetermined event has occurred;
selecting a first remote user that is affected by the predetermined event;
associating the selected telephone number with the selected user;
delivering an alert to the particular user that the predetermined event has occurred, the alert including the associated telephone number;
identifying a return call from the particular user by detecting the dialed telephone number;
receiving, at the host station, at least one user instruction for responding to the predetermined event; and
disassociating the associated telephone number from the particular user so that telephone number can be used in a subsequent alert delivery.

2. A method according to claim 1 wherein associating one of the telephone numbers with a particular user when the predetermined event has occurred includes:
selecting one of the telephone numbers when the predetermined event has occurred;
selecting a first remote user that is affected by the predetermined event; and
associating the selected telephone number with the selected user.

3. A method according to claim 2, wherein identifying the selected user further comprises:
entering an identifier by the selected user; and
comparing the identifier with a stored identifier for the selected user.

4. A method according to claim 1, wherein the host station receives at least one user instruction in the form of a voice command.

5. A method according to claim 4, and further comprising providing an interface station for connection to the host station, the voice command being recognized at the interface station and transmitted to the host station as command data.

6. A method according to claim 5, wherein the interface station presents a dialog to the selected user including information relating to the predetermined event to thereby prompt the selected user to enter the at least one user instruction.

7. A method according to claim 6, wherein the dialog includes information relating to the selected user.

8. A method according to claim 7, wherein the information relating to the selected user includes a user name.

9. A method according to claim 1, wherein delivering the alert to the selected user includes dialing a number to connect with at least one of a pager, wireless phone, and wired telephone associated with the selected user.

10. A method according to claim 1, wherein the predetermined event is a bid for an auction item that is higher than a previous bid for the auction item by the selected user.

11. A method according to claim 10, and further comprising providing a second database with information relating to the auction item and the selected user.

12. A method according to claim 1 1, wherein the information relating to the auction item includes a first high bid for the auction item.

13. A method according to claim 12, wherein receiving the at least one user instruction includes receiving a second high bid that is greater than the first high bid, the second database being updated in response to the at least one user instruction.

14. A method according to claim 13, and further comprising:
selecting a new telephone number from one of the telephone numbers of the first database when the second high bid is received;
selecting a second remote user that is affected by the predetermined event, the second remote user being different from the first remote user;
associating the new telephone number with the second selected user; and
delivering an alert to the second selected user that the second high bid has been received, the alert including the new telephone number.

15. A method according to claim 14, and further comprising:
connecting the second selected user to the host station through the new telephone number;
identifying the selected user by detecting the dialed new telephone number;
receiving, at the host station, at least one second user instruction for responding to the second high bid; and
disassociating the new telephone number from the second selected user so that the new telephone number can be used in a subsequent alert delivery.

16. A processor-based method for processing and communicating auction information between a host station and remote users, the method comprising:
providing a first database with a plurality of telephone numbers that remote users can call to communicate with the host station;
providing a second database with auction information including a first high bid from one remote user for an auction item;
selecting one of the telephone numbers upon receipt of a second high bid that is greater than the first high bid;
associating the selected telephone number with the one user;
delivering an alert to the one user that the first high bid has been exceeded, the alert including the selected telephone number;
dialing the selected telephone number by the one user to connect the one user to the host station;
identifying the one user by detecting the dialed telephone number;
receiving, at the host station, at least one instruction from the one user for responding to the second high bid; and
disassociating the selected telephone number from the one user so that the selected telephone number can be used in a subsequent alert delivery.

17. A method according to claim 16, wherein identifying the one user further comprises:
entering an identifier by the one user; and
comparing the identifier with a stored identifier for the one user.

18. A method according to claim 16, and further comprising:
selecting a new telephone number from one of the telephone numbers of the first database upon receipt of a third high bid that is greater than the second high bid;
associating the new telephone number with a further user; and
delivering an alert to the further user that the third high bid has been received, the alert including the new telephone number.

19. A method according to claim 18, and further comprising:
dialing the new telephone number by the further user to connect the second selected user to the host station;
identifying the further user by recognizing the new telephone number;
receiving, at the host station, at least one instruction from the further user for responding to the third high bid; and
disassociating the new telephone number from the further user so that the new telephone number can be used in a subsequent alert delivery.

20. A method according to claim 18, wherein delivering the alert to the users includes dialing, from the host station, a respective number associated with at least one of a pager, wireless phone, and wired telephone of each users.

21. A method according to claim 16, wherein delivering the alert to the one user includes dialing, from the host station, a number associated with at least one of a pager, wireless phone, and wired telephone of the one user.

22. A processor-based method for responding to a predetermined event associated with a host station and remote users, the method comprising:
providing a first database with a plurality of unique address identifiers that remote users can use to communicate with the host station;
associating one of the address identifiers with a particular user when the predetermined event has occurred;
selecting a first remote user that is affected by the predetermined event;
associating the selected address identifier with the selected user;
delivering an alert to the particular user that the predetermined event has occurred, the alert including the associated address identifier;
identifying a response from the particular user by detecting the selected address identifier;
receiving, at the host station, at least one user instruction for responding to the predetermined event; and
disassociating the selected address identifier from the particular user so that address identifier can be used in a subsequent alert delivery.
